(19) United States
(12) Patent Application Publication
(10) Pub. No.: US 2024/0220562 A1
(43) Pub. Date: Jul. 4, 2024

(54) METHOD, APPARATUS, DEVICE, AND MEDIUM FOR SHOWING SEARCH RESULTS

(71) Applicant: Beijing Bytedance Network Technology Co., Ltd., Shijingshan District, Beijing (CN)

(72) Inventors: Chen WANG, Beijing (CN); Yining HOU, Beijing (CN); Liping ZHU, Beijing (CN)

(21) Appl. No.: 18/564,732

(22) PCT Filed: May 11, 2022
(86) PCT No.: PCT/CN2022/092158

§ 371 Date: Nov. 28, 2023

(30) Foreign Application Priority Data
Jul. 30, 2021 (CN) 202110875449.2

(51) Int. Cl. G06F 16/9538

(52) U.S. Cl. CPC G06F 16/9538

(57) ABSTRACT

The present disclosure relates to a method, apparatus, device, and medium for showing search results. The method includes: receiving a search word corresponding to a plurality of search intents; obtaining keywords indicating the respective search intents and search results corresponding to the respective keywords; generating a first search result page showing the respective keywords, and a second search result page showing the search results corresponding to the respective keywords; wherein the keywords are configured to filter the search results corresponding to the respective keywords; showing the second search result page, and showing the first search result page at a predefined position of the second search result page, in response to a first triggering operation on the second search result page.

This application claims priority to Chinese patent application No. 202110875449.2, filed with the Chinese Patent Office on Jul. 30, 2021, and entitled “METHOD, APPARATUS, DEVICE AND MEDIUM FOR SHOWING SEARCH RESULTS”, the entire content of which is incorporated herein by reference.

### TECHNICAL FIELD

The present disclosure relates to the field of computer technology and, in particular, to a method, apparatus, device, and medium for showing search results.

### BACKGROUND

The current comprehensive search engine, sorts comprehensively search results each of which meets the search criteria throughout the Internet, and then presents each of the sorted search results to a user, usually based on a comprehensive measurement such as the relevance between a search word and the search result, the content quality of the search result, and the like factors.

For a general search word with a more general search intent, each of the corresponding search results often covers a plurality of categories, but the search intent of a user is usually one or more of the plurality of categories. There is a requirement for a user to select and consume from the respective search results presented by the comprehensive search engine, which undoubtedly increases the difficulty for a user to obtain a desired search result and reduces the efficiency of filtering the search results.

### SUMMARY

In order to solve the above technical problems or at least partially solve the above technical problems, the present disclosure provides a method, apparatus, device, and medium for showing search results.

In a first aspect, the present disclosure provides a method for showing search results, the method comprising:

receiving a search word that corresponds to a plurality of search intents;

obtaining keywords indicating the respective search intents and search results corresponding to the respective keywords;

generating a first search result page and a second search result page; wherein the first search result page is configured to show the respective keywords, wherein the second search result page is configured to show the search results corresponding to the respective keywords; and wherein the keywords are configured to filter the search results corresponding to the respective keywords shown on the second search page; and

showing the second search result page, and showing the first search result page at a predefined position of the second search result page, in response to a first triggering operation on the second search result page.

In a second aspect, the present disclosure provides an apparatus for showing search results, the apparatus comprises:
a search word receiving module, configured to receive a search word that corresponds to a plurality of search intents;
a keyword obtaining module, configured to obtain keywords indicating the respective search intents and search results corresponding to the respective keywords;
a search result page generating module, configured to generate a first search result page and a second search result page; wherein the first search result page is configured to show the respective keywords, wherein the second search result page is configured to show the search results corresponding to the respective keywords; and wherein the keywords are configured to filter the search results corresponding to the respective keywords showed on the second search page; and
a search result page showing module, configured to show the second search result page, and to show the first search result page at a predefined position of the second search result page, in response to a first triggering operation on the second search result page.

In a third aspect, the present disclosure provides a device for showing search results, the device comprises:
a processor; and
a memory, configured to store executable instructions;
wherein, the processor is configured to read the executable instructions from the memory, and execute the executable instructions to implement the method for showing search results described in the first aspect.

In a fourth aspect, the present disclosure provides a computer-readable storage medium comprising computer programs stored thereon, when executed by a processor, causing the processor to implement the method for showing search results described in the first aspect.

In a fifth aspect, the present disclosure provides a computer program product comprising computer programs carried on a non-transitory computer-readable medium, the computer program containing program codes for executing the method for showing search results described in the first aspect.

The method, apparatus, device, and medium for showing search results of embodiments of the present disclosure, are capable of obtaining keywords indicating the respective search intents and search results corresponding to the respective keywords, after receiving a search word input by a user that corresponds to a plurality of search intents; generating a first search result page based on the respective keywords and a second search result page based on the search results corresponding to the respective keywords; subsequently, showing the second search result page, and showing the first search result page at a predefined position of the second search result page, in response to a first triggering operation on the second search result page. It is achieved that the displaying of the first search result page containing the keywords corresponding to the respective search contents of the search word is triggered through an interaction operation on the second search result page, which not only can avoid the reading interference led by directly displaying the respective keywords to a user, but also can filter all the search results of the search word with the keywords, and thus improves the efficiency of filtering the search results.

### BRIEF DESCRIPTION OF THE DRAWINGS

The foregoing and other features, advantages, and aspects of embodiments of the present disclosure will become more apparent in conjunction with the accompanying drawings and with reference to the detailed description below. Throughout the accompanying drawings, the identical or similar reference signs indicate the identical or similar elements. It should be understood that the accompanying drawings are schematic and that the components and elements are not necessarily scaled.

FIG. 1 is a schematic flow diagram of a method for showing search results provided by embodiments of the present disclosure;

FIG. 2 is a schematic diagram of a second search result page provided by embodiments of the present disclosure;

FIG. 3 is a schematic diagram of a first search result page provided by embodiments of the present disclosure;

FIG. 4 is a schematic diagram of another first search result page provided by embodiments of the present disclosure;

FIG. 5 is a schematic diagram of yet another first search result page provided by embodiments of the present disclosure;

FIG. 6 is a schematic diagram of yet another first search result page provided by embodiments of the present disclosure;

FIG. 7 is a schematic flow diagram of another method for showing search results provided by embodiments of the present disclosure;

FIG. 8 is a schematic diagram of yet another first search result page provided by embodiments of the present disclosure;

FIG. 9 is a schematic diagram of yet another first search result page provided by embodiments of the present disclosure;

FIG. 10 is a schematic diagram of the structure of an apparatus for showing search results provided by embodiments of the present disclosure; and

FIG. 11 is a schematic diagram of the structure of a device for showing search results provided by embodiments of the present disclosure.

### DETAILED DESCRIPTION

Embodiments of the present disclosure will be described in greater detail with reference to the accompanying drawings. Although certain embodiments of the present disclosure are shown in the accompanying drawings, it should be understood that the present disclosure may be implemented in various forms and should not be construed as being limited to the embodiments set forth herein, but rather these embodiments are provided for a more thorough and complete understanding of the present disclosure. It should be understood that the accompanying drawings and embodiments of the present disclosure are only for exemplary purposes and are not intended to limit the scope of protection of the present disclosure.

It should be understood that the various steps recorded in implementations of the method of the present disclosure may be executed in a different order, and/or in parallel. Furthermore, the implementations of the method may include additional steps and/or omit executing the illustrated steps. The scope of the present disclosure is not limited in this regard.

As used herein, the term “including” and its variations are open-ended, i.e. “including but not limited to”. The term “based on” is “based at least in part on”. The term “one embodiment” means “at least one embodiment”; the term “another embodiment” means “at least one additional embodiment”; the term “another embodiment” means “at least one other embodiment”; and the term “some embodiments” means “at least some embodiments”. Related definitions of other terms will be given in the description below.

It should be noted that the concepts of “first”, “second” and the like mentioned in the present disclosure are only used to distinguish different apparatuses, modules, or units, and are not used to define the order or interdependence of the functions performed by these apparatus, modules or units.

It should be noted that the qualifiers of “one” and “a plurality of” mentioned in the present disclosure are schematic rather than limiting, and those skilled in the art should understand that they should be understood as “one or more” unless the context clearly indicates otherwise.

The names of the messages or information interacted between the plurality of apparatuses of the implementations of the present disclosure are only for illustrative purposes and are not intended to limit the scope of those messages or information.

A search engine generally obtains all search results according to a search word, then comprehensively measures each of the search results based on various factors, sorts the search results, and then presents each of the sorted search results to a user. When the search word input by the user is a general search entry, the respective search results returned by the search engine are arranged in such a manner that the search results of a plurality of search intents (or categories) corresponding to the search word are mixed. If the user wants to consume the search results of the search intent that he/she is interested in, there is a requirement for the user to select and consume from all the search results, resulting in a low efficiency in the filtering search results of the user.

In order to solve the above problem, embodiments of the present disclosure provide a method, apparatus, device, and medium for showing search results, which displays keywords of the respective search intents corresponding to the search word through an interaction operation on the comprehensive search result page in the scenario of general search. The keyword corresponds to a category of the search results among the search results corresponding to the search word, thereby improving the efficiency of filtering the search results on the basis of avoiding the reading interference led by directly displaying the respective keywords to the user.

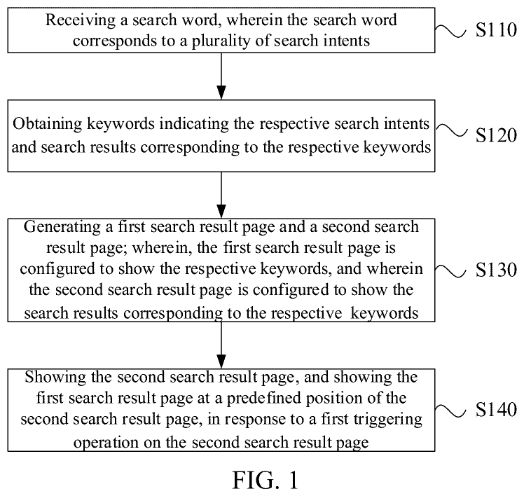

The method for showing search results provided by embodiments of the present disclosure is firstly described below in conjunction with FIGS. 1-9.

In embodiments of the present disclosure, the method for showing search results may be performed by an electronic device. Herein, the electronic device may include but is not limited to a mobile terminal such as a mobile phone, a laptop computer, a digital broadcast receiver, a PDA (personal digital assistant), a PAD (tablet computer), a PMP (portable multimedia player), an in-vehicle terminal (e.g., a vehicle navigation terminal), a wearable device, and the like, as well as a fixed terminal such as a digital TV, a desktop computer, a smart home device, and the like.

FIG. 1 illustrates a schematic flow diagram of the method for showing search results provided by embodiments of the present disclosure. As shown in FIG. 1, the method for showing search results may comprises the following steps:
S110: receiving a search word, wherein the search word corresponds to a plurality of search intents.

Herein, the search word is a content input by the user that requires the search engine to execute a search operation and to return search results. Considering that embodiments of the present disclosure are applied to a scenario of the general search, the search word may be a keyword or a phrase. A search intent (also referred to as “a user intent”) refers to the most important goal that the user wants to achieve when the search engine is searching. In embodiments of the present disclosure, the search intent is a search goal(s) that can be covered by the search word.

In one possible implementation, the search intent is a polysemous term search intent or a multi-topic search intent. The polysemous search intent refers to the search intent corresponding to each semantic item when the search word contains a plurality of semantic items. The multi-topic search intent refers to the search intent corresponding to the scope or topic that can be related to a search word when the search word is a general search word with an ambiguous meaning. The type of the search intent is specifically determined according to the type of the search word. For example, if the search word is the polysemous word, the search intent is the polysemous search intent; and also, if the search word is in a general search word, the search intent is a multi-topic search intent. The process of determining the type of the search intent and the respective search intents by the search word can be seen in the related description related to the server in subsequent embodiments.

Specifically, an electronic device may receive a search word input by a user in a search page of a particular application or a particular website.

In some embodiments, the user may enter information in any of the forms of text, voice, image, and the like, into a search box in the search page, to cause the electronic device to use the word corresponding to the information input by the user as the search word input by the user.

For example, the user may enter text information “Li XX” into the search box in the search page, and the electronic device may use “Li XX” as the search word and then search for content associated with “Li XX” for the user.

For another example, the user may enter voice information “Li XX” into the search box in the search page, and the electronic device may perform voice a recognition processing on the voice information to obtain the search word “Li XX”, and then search for the content associated with “Li XX” for the user.

For yet another example, the user may enter an image with the text “Li XX” or an image with the content of the picture of “Li XX” into the search box in the search page, and the electronic device may perform an image text recognition processing or image content recognition processing on the image to obtain the search word “Li XX”, and then search for the content associated with “Li XX” for the user.

In other embodiments, the search page may also comprise a plurality of candidate search words displayed thereon, and the user may make a selection from the displayed candidate search words, so that the electronic device uses the candidate search word selected by the user as the search word.

For example, the search page may comprise the candidate search words displayed thereon such as “dress”, “spring and summer clothing”, “wear”, and the like, the user may select “dress”, so that the electronic device may use the “dress” selected by the user as the search word, and then search for content associated with the “dress” for the user.

In the embodiments of the present disclosure, after the electronic device receives the search word input by the user, the search word may be sent to a server.

The server may perform searching based on the search word, to obtain the respective search results corresponding to the search word. The server may also analyze the search word and/or the respective search results corresponding to the search word, and determine a type of search intent corresponding to the search word, the respective search intents, a keyword corresponding to each search intent, and a category of search results corresponding to the corresponding keyword. The keyword herein refers to information that can describe the corresponding search intent.

In some embodiments, a thesaurus is pre-set in the server, and a plurality of words, a type of search intent, and the specific search intents corresponding to each of the words are stored in the thesaurus. The server matches the search word with the words in the thesaurus, determines the type of the search intent corresponding to the word with the highest matching degree as the type of the search intent corresponding to the search word, and determines the specific search intents corresponding to that word as the respective search intents corresponding to the search word. Then, the server categorizes or aggregates the respective search results of the search word according to the respective determined search intents, so as to obtain one category of search results corresponding to the respective search intents of the search word. The setting of the thesaurus described above can improve the search efficiency of the server.

In other embodiments, the server firstly queries whether the search word is a polysemous entry or not, according to a specialized entry interpretation tool such as an encyclopedia. If so, then the type of the search intent of the search word is determined to be the polysemous search intent, and each semantic item of the search word is determined to be the search intent of the search word. Then, the respective search results corresponding to the search word are sorted according to the respective determined search tents, and one category of the search results corresponding to each search intent of the search word is obtained. For example, the search word is “Li XX”, which has polysemous in the encyclopedia such as “poet Li XX”, “game character Li XX” and “song Li XX”, and then “poet Li XX”, “game character Li XX” and “song Li XX” are determined as three search intents of the search word “Li XX”.

If the above query determines that the search word is not the polysemous entry, the type of search intent of the search word is determined to be a multi-topic search intent. Then, the server performs word matching for the search word from the pre-set thesaurus. Then, the server determines the type of the search intent corresponding to the word with the highest matching degree as the type of the search intent corresponding to the search word, and determines the specific search intents corresponding to the word as the respective search intents corresponding to the search word. Subsequently, the server categorizes and aggregates the respective search results of the search word according to the respective determined search intents, so as to obtain one category of search results corresponding to each search intent of the search word. The setting of the specialized entry interpretation tool above such as the encyclopedia in conjunction with the thesaurus, can improve the search efficiency of the server on the basis of reducing the workload of the construction of the thesaurus.

In other embodiments, instead of setting the thesaurus previously, the server analyzes the search words and the search results thereof in real-time to determine information related to the search intent of the search word.

The same as the previous embodiment, the server firstly queries for the search word according to the specialized entry interpretation tool such as the encyclopedia and the like. If it is queried, the type of the search intent of the search word, the respective search intents, and one category of search results corresponding to the respective search intents are determined in the same manner.

If the above query determines that the search word is not the polysemous entry, the type of the search intent of the search word is determined to be a multi-topic search intent. Then, the server performs keyword extraction on all search results corresponding to the search word to obtain respective keywords. Moreover, the server filters the respective keywords to obtain a keyword that has a representativity (e.g., a larger quantity of the search results corresponding to the keyword) and has a certain degree of difference (e.g., a lower degree of similarity among the respective keywords) from the respective keywords as the respective search intents corresponding to the search word. Afterwards, the server categorizes and aggregates all the search results of the search word according to the respective filtered search intents, so as to obtain one category of search results corresponding to the respective keywords of the search word.

The way of keyword extraction described above may be to extract the keywords directly from the respective search results; and may also be to extract the core content thereof from the respective search results first, and then to extract the keyword from the core content. Regardless of the way of keyword extraction, the specific way of extraction is different for different search results. For example, for the search result with a good webpage structure, structured information may be extracted directly from the search result as the keyword. For another example, for the search result with a poor webpage structure, the search word corresponding to the search result which is consumed may be determined as the keyword corresponding to the result. For yet another example, for long-tail content, the keyword extraction may be implemented through self-learning of a machine learning model.

It is noted that the process of the thesaurus construction in each of the above embodiments may be the same as the process of analyzing each of the search results to determine information related to the search intent described above.

On the basis of each of the above embodiments, the server may determine the keywords of the corresponding search intent according to one category of search results corresponding to the search intent. For example, if a search intent is “game character Li XX”, the server may perform information extraction on one category of search results of the search intent to determine that the keyword of the search intent is “the hero of XX game, assassin”. For another example, if one certain search intent of a search word “dress” is “wear”, the server may perform the information extraction on one category of search results of the search intent to determine that the keywords of the search intent may contain “wear”, “spring/summer”, “petite” and etc.

After the process described above, the server may return a plurality of search intents of the determined search word, as well as keywords and search results corresponding to the respective search intents to an electronic device.
S120: keywords indicating the respective search intents and search results corresponding to the respective keywords are obtained.

Specifically, the electronic device receives information returned from the server and determines therefrom the keywords corresponding to the respective search intents, and one category of the search results corresponding to each keyword.
S130: a first search result page and a second search result page are generated; wherein, the first search result page is configured to show the respective keywords, and the second search result page is configured to show the search results corresponding to the respective keywords.

The first search result page and the second search result page are both pages configured to show the searched results of the search word. The keywords are configured to filter the search results corresponding to the respective keywords. By the above description, it is understood that one category of search results corresponding to one keyword is a result of filtering all search results corresponding to the search word by the keyword. The search results corresponding to the respective keywords may form all the search results corresponding to the search word.

Specifically, it is considered that the keywords corresponding to the respective search intents are displayed directly and fixedly on the search result page, it is easy to cause the keywords to be confused with titles of categories in the search result page (e.g., “General”, “Picture”, “Video”, etc. at the top of the page), thus leading reading interference to the user. In the embodiment of the present disclosure, two pages (i.e., the first search result page and the second search result page) are differentiated to show respectively the keywords corresponding to the respective search intents and the search results corresponding to the respective keywords. Therefore, after obtaining the keywords corresponding to the respective search intents and the search results corresponding to the respective keywords, the electronic device generates the first search result page according to the keywords corresponding to the respective search intents, and generates the second search result page according to the search results corresponding to the respective keywords, wherein the second search result page is a search result page obtained from a comprehensive search.
S140: the second search result page is shown, and the first search result page is shown at a predefined position of the second search result page in response to a first triggering operation on the second search result page.

The first triggering operation refers to a triggering operation performed on the second search result page to discover hidden functionalities (e.g., showing the keywords in the present disclosure). The first triggering operation may be a gesture operation such as swiping along one certain direction, or multi-finger tapping, etc., or a non-contact operation such as voice control or eye movement control. The first triggering operation being the swiping along one certain direction (e.g., swiping upward, swiping downward, swiping leftward, swiping rightward) will be illustrated in the embodiments of the present disclosure as an example. The predefined position is a pre-set display position, which may be a display position of the second search result page or a display position of another page having a certain associated relationship with the second search result page.

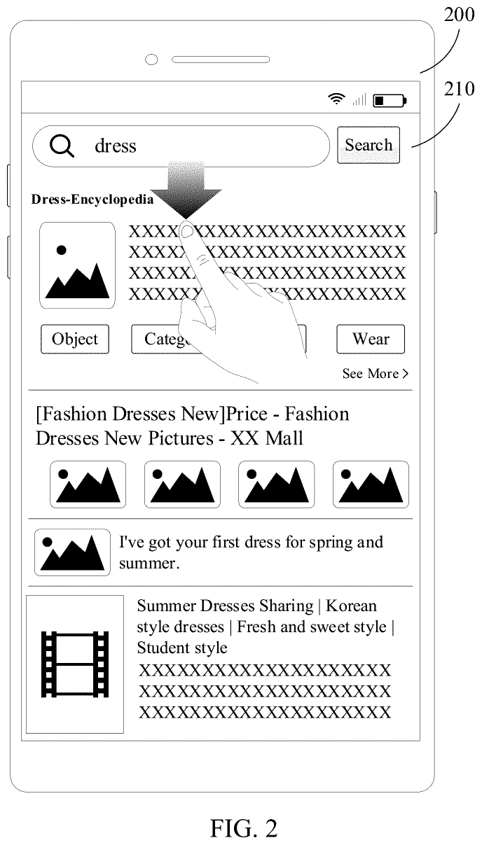

Specifically, the electronic device displays the second search result page as a default, after triggering a search for a search word. As shown in FIG. 2, the electronic device 200 displays a second search result page 210, after triggering a search for the search word “dress”. The second search result page 210 comprises a plurality of search results relating to the dress displayed thereon.

If the first triggering operation of the user on the second search result page is detected by the electronic device, the first search result page is displayed at the predefined position of the second search result page, to present the keywords of the respective search intents corresponding to the search word to the user. Each keyword corresponds to one category of search results from the respective search results corresponding to the search word, and thus the user may implement quick filtering on all search results through these keywords.

It is noted that the display size of the first search result page is at least capable of accommodating all of the keywords. The display position of the respective keywords on the first search result page may not be limited.

In one implementation provided in the present disclosure, the predefined position is a hover window on the second search result page. Then, showing the first search result page at the predefined position of the second search result page comprises: creating the hover window on the second search result page, and showing the first search result page in the hover window.

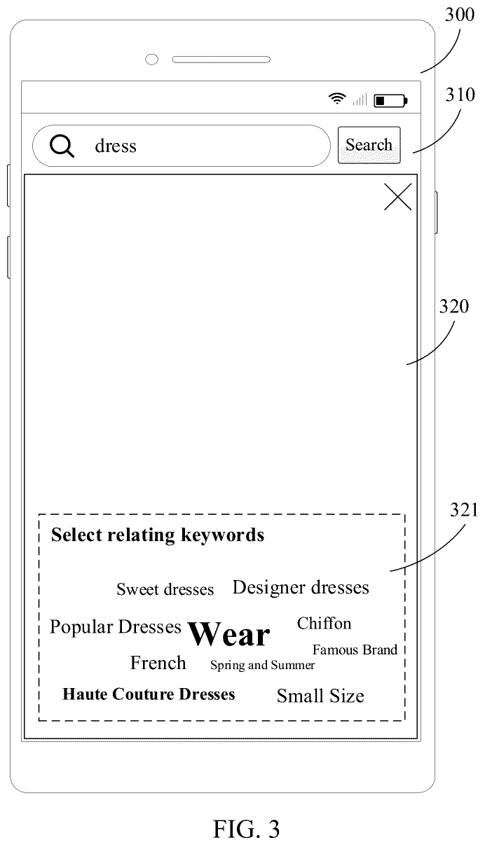

Continuing to refer to FIG. 2, when the user performs an operation of swiping downward on the second search page 210, the electronic device creates the hover window on the second search result page 210 and displays the first search result page in the form of the hover window, whose display effect is shown in FIG. 3. In FIG. 3, the electronic device 300 comprises a second search result page 310 displayed thereon, and a first search result page 320 is displayed in the form of a floating layer above the second search result page 310. The first search result page 320 comprises a plurality of keywords 321 corresponding to the search word “dress” displayed thereon.

In another implementation provided by the present disclosure, the predefined position is a new page overlaying the second search result page. Then, showing the first search result page at the predefined position of the second search result page comprises: showing the first search result page overlaying on the second search result page.

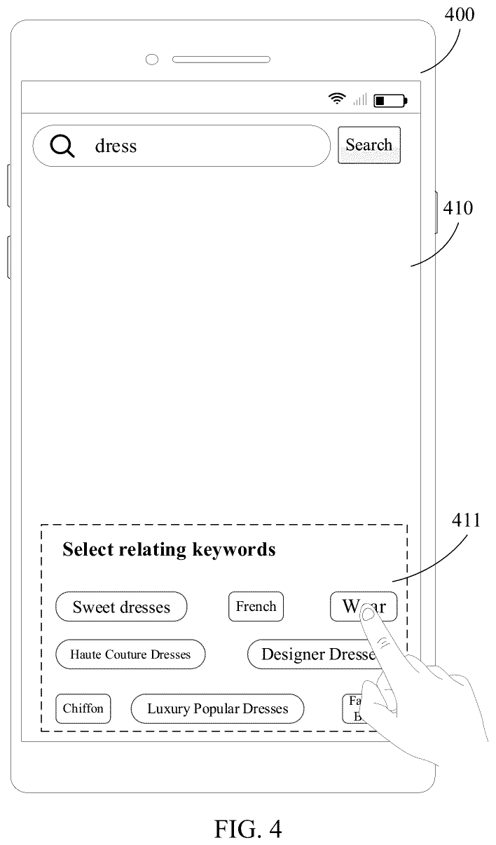

Continuing to refer to FIG. 2, when the user performs the operation of swiping downward on the second search page 210, the electronic device displays the first search result page overlaying on the second search result page 210, whose display effect is shown in FIG. 4. In FIG. 4, the electronic device 400 displays the first search result page 410 therein, and the first search result page 410 comprises a plurality of keywords 411 corresponding to the search word “dress” displayed thereon.

In yet another implementation provided by the present disclosure, the predefined position is the position at which the second search result page is located, and the first search result page is a new page adjacent to the second search result page in an opposite direction to the operation direction of the first triggering operation. Then, showing the first search result page at the predefined position of the second search result page comprises: swiping from the second search result page to the first search result page along the operation direction of the first triggering operation.

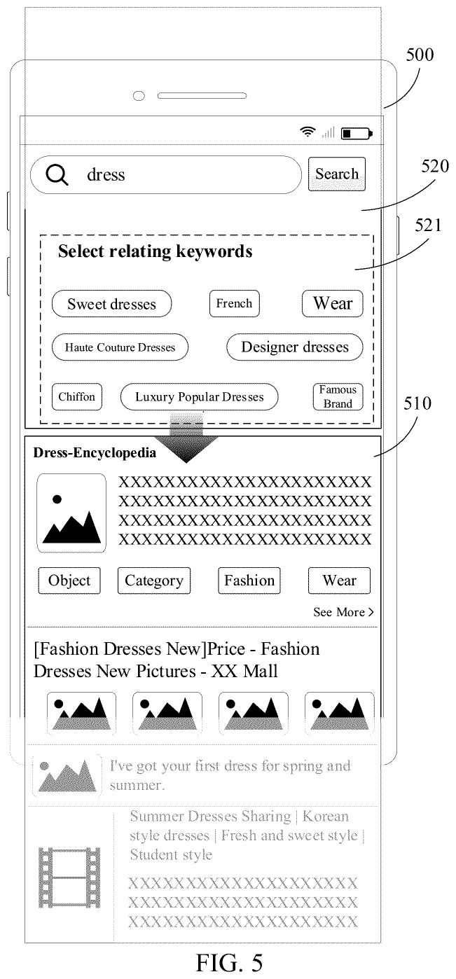

Continuing to refer to FIG. 2, when the user performs the operation of swiping downward on a second search page 210, the electronic device swipes the second search result page 210 downward, and swipes the first search result page adjacent to the top of the second search result page 210 to be in the display interface of the electronic device to display at the same time, whose display effect is shown in FIG. 5. In FIG. 5, the second search result page 510 in the electronic device 500 is gradually moved downward out of the display interface of the electronic device 500 (the part that has been moved out is shown in light gray, and is not visible in practice), while the first search result page 520 at the top of the second search result page 510 is gradually moved into the display interface of the electronic device 500 at the same speed (the part that has not been moved into is shown in light gray, and is not visible in practice), until the first search result page 520 is entirely moved into the display interface of the electronic device 500. If the two pages are of the same size, the second search result page 510 will then entirely move out of the display interface. The first search result page 520 displays the respective keywords 521 thereon.

In yet another implementation provided by the present disclosure, the predefined position is a certain position of the second search result page. Then, showing the first search result page at the predefined position of the second search result page comprises: moving the search results corresponding to the respective keywords on the second search result page along the operation direction of the first triggering operation, and displaying the first search result page on the vacated area of the second search result page. That is, the first search result page is displayed on the second search result page, and the respective search results on the second search result page are moved in sequence along the opposite direction of the display position of the first search result page.

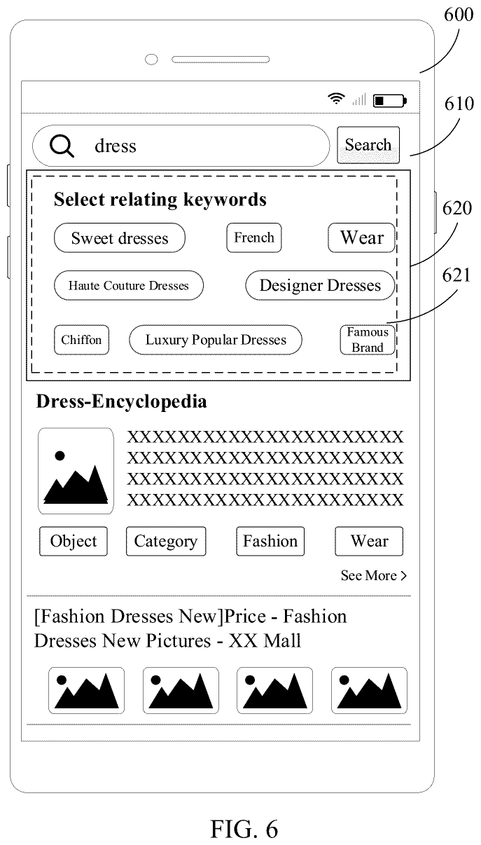

Continuing to refer to FIG. 2, when the user performs the operation of swiping downward on the second search page 210, the electronic device moves the respective search results on the second search result page 210 downward in sequence, until an area of the same size as that of the first search result page is vacated at the top of the second search result page 210, and then displays the first search result page on the vacated area at the top of the second search result page 210, whose display effect is shown in FIG. 6. In FIG. 6, the electronic device 600 displays a second search result page 610 therein. The area at the top of the second search result page 610 displays the first search result page 620 therein, and the first search result page 620 displays the respective keywords 621 thereon.

Based on the illustration of each of the above implementations, the respective keywords on the first search result page are shown in a diverse display style.

In some embodiments, the respective keywords are displayed on the first search result page in the same style of displaying, as shown by the respective keywords shown in FIGS. 4, 5, and 6. These keywords may be displayed on the first search result page in a random sequence, or the keywords may be displayed in a sorted sequence according to the relevance between the keyword and the search word and/or the click-through rate of the keyword (indicates the hotness of the keywords).

In other embodiments, the respective keywords are shown on the first search result page in a distinguishable display style. As shown in FIG. 3, the respective keywords 321 are displayed on the first search result page 320 in the form of a keyword map. The display styles of these keywords are determined based on the relevance of the corresponding keyword to the search word and/or the click-through rate of the keyword. For example, the higher the relevance and the higher the click-through rate of the keyword, the more prominent their display style is. The display style herein comprises at least one of a font size, a color, a display position, and a showing area of the search result.

Continuing with FIG. 3, the keyword “wear” has a certain relevance to “dress” and has the highest click-through rate, so the keyword “wear” is displayed in the center position with the largest bold font. “Big brand” has the least relevance to “dress” or has the lowest click-through rate, so the keyword “big brand” will be displayed at the edge position and in the smallest non-bold font.

The technical solution for showing search results described above is capable of obtaining keywords indicating the respective search intents and search results corresponding to the respective keywords, after receiving a search word input by a user that corresponds to a plurality of search intents; generating a first search result page based on the respective keywords and a second search result page based on the search results corresponding to the respective keywords; subsequently, showing the second search result page, and showing the first search result page at a predefined position of the second search result page, in response to a first triggering operation on the second search result page. It is achieved that the displaying of the first search result page containing the keywords corresponding to the respective search contents of the search word is triggered through an interaction operation on the second search result page, which not only can avoid the reading interference led by directly displaying the respective keywords to a user, but also can filter all the search results of the search word with the keywords, and thus improves the efficiency of filtering the search results.

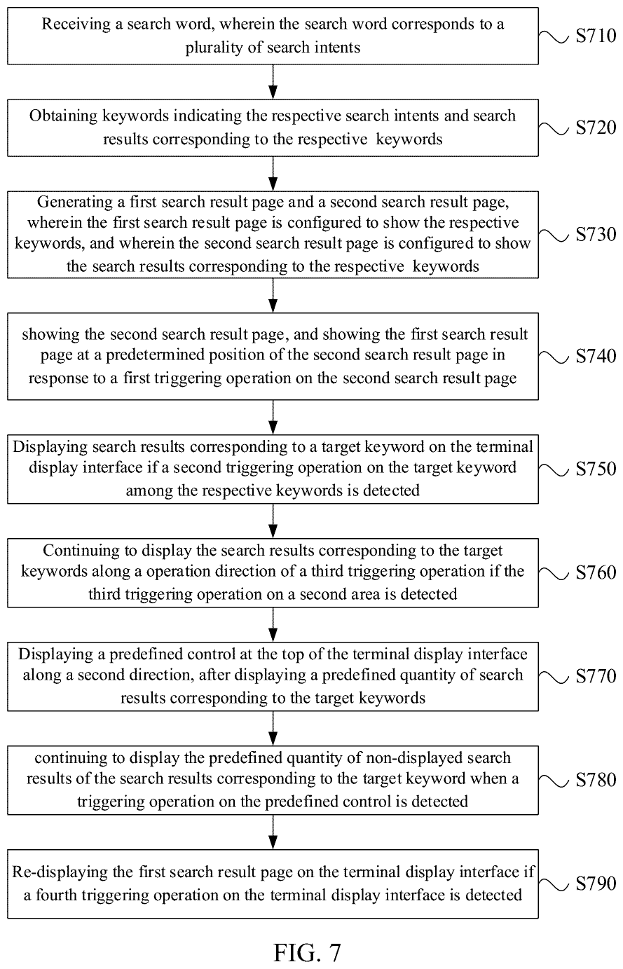

FIG. 7 illustrates a schematic flow diagram of another method for showing search results provided by the embodiments of the present disclosure. As shown in FIG. 7, the method for showing search results may include the following steps:
S710: receiving a search word, wherein the search word corresponds to a plurality of search intents;
S720: obtaining keywords indicating the respective search intents and search results corresponding to the respective keywords;
S730: generating a first search result page and a second search result page, wherein the first search result page is configured to show the respective keywords, and wherein the second search result page is configured to show the search results corresponding to the respective keywords;
S740: showing the second search result page, and showing the first search result page at a predefined position of the second search result page in response to a first triggering operation on the second search result page; and
S750: if a second triggering operation on a target keyword among the respective keywords is detected, displaying the search results corresponding to the target keyword on the terminal display interface.

Herein, the second triggering operation refers to an operation triggered by selecting the keyword, which may be, for example, a click operation, or a non-contact triggering operation such as voice control, gesture control, and eye movement control. The terminal display interface refers to the current display interface in an electronic device.

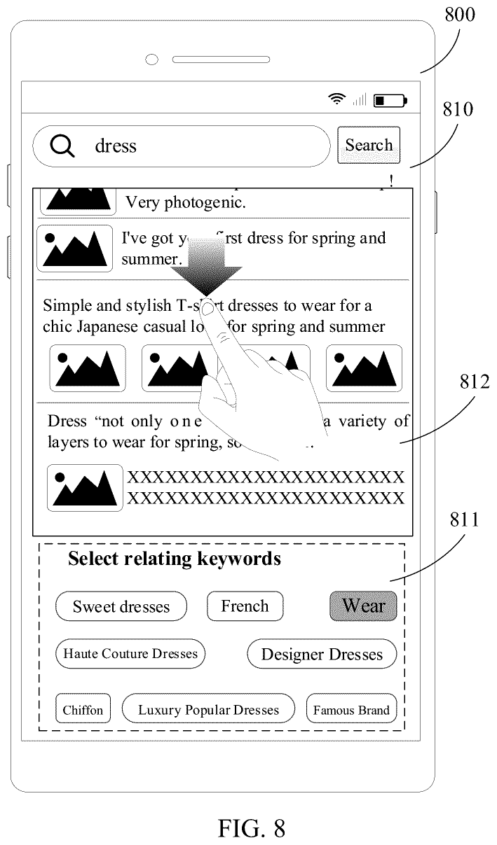

Specifically, after displaying the first search result page, if the second triggering operation by the user for a certain keyword (i.e., the target keyword) among the respective keywords is detected by the electronic device, in response to the second triggering operation, the electronic device displays at least a portion of the search results from one category of the search results corresponding to the target keyword on the terminal display interface. Additionally, the target keyword may be displayed in a selected state when the second triggering operation is detected. For example, if the user clicks on the keyword “wear” in FIG. 4 to trigger, the keyword “wear” is displayed as a gray shading, whose display effect is shown as the respective keywords 811 in FIG. 8.

At least some of the search results in the category of the search results corresponding to the target keyword may be displayed overlaying the respective keywords, or may be displayed in a display area other than the respective keywords.

It should be noted that if the user triggers two or more target keywords, the search results corresponding to the target keyword displayed may be a simple combination (e.g., a direct merge) of the search results corresponding to the plurality of target keywords, or may be reordered comprehensive search results of the search results corresponding to a plurality of target keywords after removing the duplicated search results.

In some embodiments, displaying the search results corresponding to the target keyword in the terminal interface in S750 comprises: displaying the first search result page in a first area of the terminal display interface; and displaying the search results corresponding to the target keyword in a second region of the terminal display interface.

Herein, the first area is an area within a setting range of the terminal display interface in the operation direction of the first trigger operation. For example, when the first triggering operation is a downward swiping, the first region is a region within the setting range at the lower middle of the terminal display interface. The setting range is a pre-set range of the area, which may be, for example, an area corresponding to ⅓ of the range of the entire display interface. The second area is the remaining area in the terminal interface other than the first area. Referring to FIG. 4, the first area is an area corresponding to ⅓ of the range of the terminal display interface at the bottom (here, the first search result page 410), and the second area is an area within ⅔ of the range of the terminal display interface at the top.

Specifically, in order to increase the continuity of user operation to a certain extent, the initial states of the search results corresponding to the respective keywords and target keywords are set to be displayed in different areas.

When the size of the first search result page is relatively small (e.g., only accommodates the respective keywords), the first search result page is displayed in a first area of the terminal display interface, and at least a portion of the search results in one category of search results corresponding to the target keyword is displayed in a second area of the terminal display interface.

When the display range of the first search result page is relatively large, such as when the size of the first search result page is the same as that of the second search result page, the terminal display interface is the first search result page. Then, the respective keywords are displayed in a first area of the first search result page (e.g., the area corresponding to ⅓ of the range of the first search result page 410 at the bottom in FIG. 4), and at least some of the search results in one category of the search results corresponding to the target keyword are displayed in the remaining region of the first search result page (e.g., the area corresponding to ⅔ of the range of the first search result page 410 at the top in FIG. 4).

As shown in FIG. 8, the electronic device 800 comprises the first search result page 810 displayed thereon, a first area at the bottom of the first search result page 810 comprises the respective keywords 811 displayed thereon, and a second area at the top of the first search result page 810 comprises at least a portion of one category of the search results 812 corresponding to the target keywords displayed thereon.

It is noted that when the size of the first search result page is relatively large, the keywords to be displayed may be filtered according to the display size of the first region and the display size of the filtered keywords. For example, firstly, all the keywords returned by the server are sorted according to the relevance of the keywords to the search word and/or the click-through rate of the keyword; and the respective keywords that can be accommodated in the first area are determined as the respective keywords displayed on the first search result page, according to the display size of each of the top sorted keywords and the display size of the first area. This can ensure the normal display of the keywords and the display of the keywords with higher quality, further improving the efficiency of filtering the subsequent search results.
S760: the search results corresponding to the target keyword are continued to be displayed along the operation direction of the third triggering operation, if a third triggering operation on the second area is detected.

Herein, the third triggering operation is an operation triggered by switching the respective search results corresponding to the displayed target keywords, which may be, for example, a swipe operation, or a non-contact triggering operation such as voice control, gesture control, and eye movement control, etc.

In one example, the operation direction of the third triggering operation may be opposite to the operation direction of the first trigger operation. For example, the first triggering operation is the operation of swiping downward, and the third triggering operation is the operation of swiping upward.

In another example, the operation direction of the third trigger operation is the same as that of the first trigger operation. For example, the first triggering operation is the operation of swiping downward, and the third triggering operation is also the operation of swiping downward, which can obtain a better continuity of operation, further increasing the user experience.

Specifically, since the second area is limited to displaying more search results, after the preliminary displaying of at least some of the search results in one category of the search results corresponding to the target keyword in S570, if the third triggering operation on the second region of the user is detected by the electronic device, it is continued to display more search results corresponding to the target keyword in the operation direction of the third triggering operation.

As shown in FIG. 8, the respective search results corresponding to the target keyword are arranged from bottom to top, and when the user performs the operation of swiping downward on the second area at the top of the first search result page 810, the electronic device 800 moves the search results displayed in the second region downward, and moves the un-displayed search results at the top of the page into the second region to display at the same time.

In one example, more search results as described above may still be displayed in the second area, i.e., both the search results and the respective keywords are displayed in the first search result page.

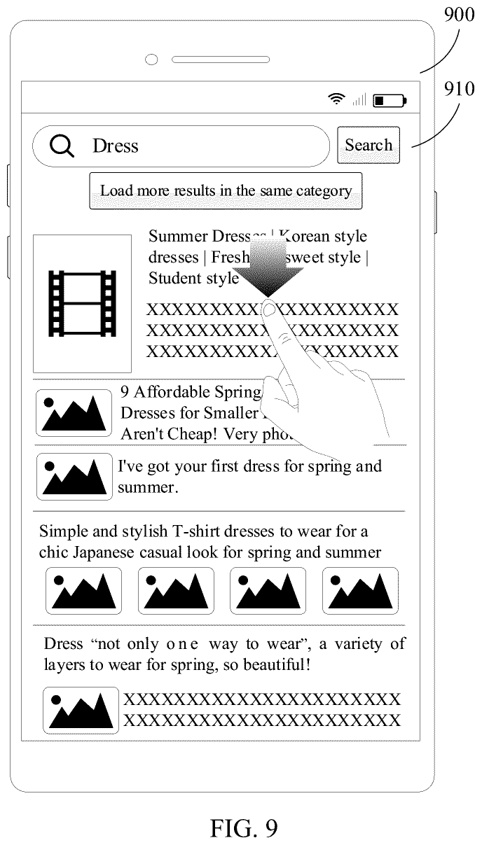

In another example, more search results as described above may also be extended to be displayed in the entire first search result page. As shown in FIG. 9, when the quantity of search results that need to be displayed and corresponding to the target keyword is relatively large, the entire first search result page 910 of the electronic device 900 is configured to display the search results. This can not only increase the quantity of the search results to be displayed, but also reduce the interference of the respective keywords to the user during the process of the user consuming the search results, improving the efficiency of the consumption of the search results.
S770: a predefined control is displayed at the top of the terminal display interface along a second direction, after displaying a predefined quantity of search results corresponding to the target keyword.

Herein, the predefined quantity is a pre-set value of the quantity, which is configured to limit the quantity of loadable search results at one time. The second direction is opposite to the operation direction of the first triggering operation. For example, the operation direction of the first triggering operation is swiping downward, and the second direction is upward. The predefined control is a control with pre-set control functionalities and the displaying timing, which is configured to trigger the continuing the display of the predefined quantity of un-displayed search results of the search results corresponding to the target keyword.

Specifically, as shown in FIG. 9, when the quantity of the displayed search results corresponding to the target keyword reaches the predefined quantity, no more search results can be displayed, and instead, a predefined control “Load more results in the same category” is displayed at the most upper top of the first search result page 910.
S780: When a triggering operation on the predefined control is detected, it is continued to display the predefined quantity of the un-displayed search results of the search results corresponding to the target keyword.

Specifically, if the electronic device detects the triggering operation on the predefined control of the user, it continues to display the predefined quantity of the un-displayed search results along the operation direction of the third triggering operation. For example, if the user clicks on the predefined control “Load more results in the same category” in FIG. 9, it is continued to display more search results downward of the first search result page 910, and the quantity of search results that continues to be displayed is up to the predefined quantity.
S790: If a fourth triggering operation on the terminal display interface is detected, the first search result page is re-played in the terminal display interface.

Herein, the fourth triggering operation is the same as the first triggering operation.

Specifically, if the user does not trigger the predefined control, but instead performs the fourth triggering operation on the terminal display interface (e.g., the first search result page), the electronic device will re-display the first search result page, as shown in FIG. 3 to FIG. 6.

The solution of interaction operations for the display of the search results corresponding to the target keyword described above is also applicable to the display scenario of the first search result page in FIGS. 3, 5, and 6, wherein it is only needed to move the display of the respective keywords to the bottom of the page with the same direction as the operation direction of the first triggering operation.

In the technical solution for showing the search results described above, if the second triggering operation on the target keyword among the respective keywords is detected, the search results corresponding to the target keyword are displayed on the terminal display interface, so as to implement filtering the search results corresponding to the respective keywords through the target keywords, improving the efficiency of filtering the search results. Additionally, if the third triggering operation on the second area is detected, it is continued to display the search results corresponding to the target keyword along the operation direction of the third triggering operation which is the same as that of the first triggering operation, and after displaying the predefined quantity of search results corresponding to the target keyword, a predefined control, which is configured to trigger the continuing to display of the predefined quantity of un-displayed search results from the search results corresponding to the target keyword, is displayed at the top of the terminal display interface along a second direction, so as to implement the interaction triggering display of more search results and be able to keep the operation direction of the user the same during the entire process, to increase the continuity of the operation, further increasing the user experience. In addition, if the fourth triggering operation on the terminal display interface is detected, the first search result page is re-displayed on the terminal display interface. The fourth triggering operation is the same as the first triggering operation, so as to implement returning to the first search result page based on the same interaction operation as the first triggering operation, so that the user can re-perform the selecting of the target keywords and the viewing of the corresponding search results, which further increases the continuity of operation, and further increases the convenience of the page return, thus further increasing the user experience.

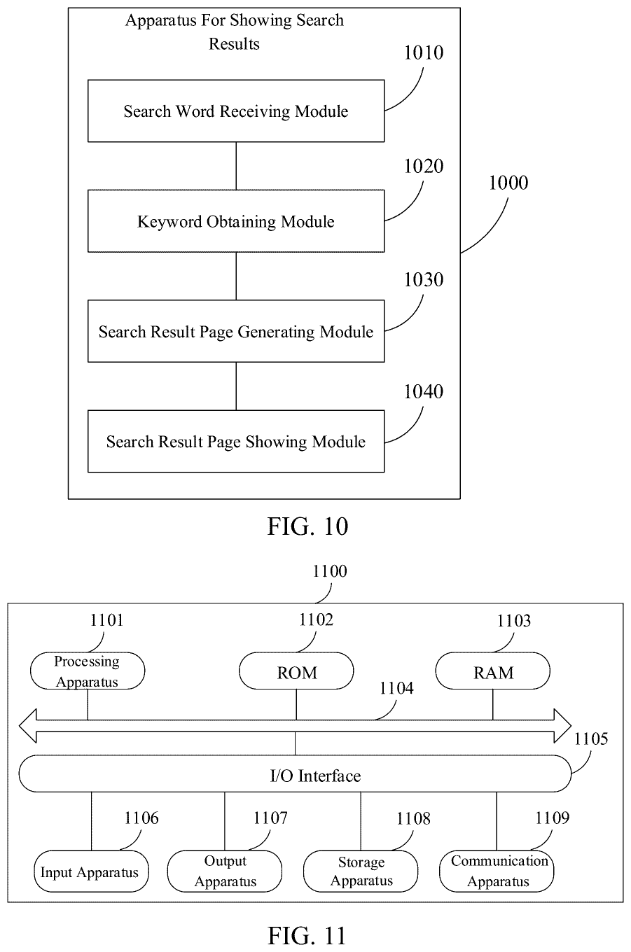

Embodiments of the present disclosure also provide an apparatus for showing search results, as described below in connection with FIG. 10.

In embodiments of the present disclosure, the apparatus for showing search results may be an electronic device. Among other things, the electronic device may include but is not limited to a mobile terminal such as a mobile phone, a laptop computer, a digital broadcast receiver, a PDA, a PAD, a PMP, an in-vehicle terminal (e.g., a vehicle navigation terminal), a wearable device, and the like, as well as a fixed terminal such as a digital TV, a desktop computer, a smart home device, and the like.

FIG. 10 illustrates a schematic diagram of the structure of an apparatus for showing search results provided by embodiments of the present disclosure.

As shown in FIG. 10, the apparatus for showing search results 1000 may comprise a search word receiving module 1010, a keyword obtaining module 1020, a search result page generating module 1030, and a search result page showing module 1040.

The search word receiving module 1010, is configured to receive a search word, and the search word corresponds to a plurality of search intents.

The keyword obtaining module 1020, is configured to obtain keywords indicating the respective search intents and search results corresponding to the respective keywords.

The search result page generating module 1030, is configured to generate a first search result page and a second search result page; wherein the first search result page is configured to show the respective keywords, and the second search result page is configured to show the search results corresponding to the respective keywords; and wherein, the keywords are configured to filter the search results corresponding to the respective keywords shown on the second search page.

The search result page showing module 1040, is configured to show the second search result page, and to show the first search result page at a predefined position of the second search result page, in response to a first triggering operation on the second search result page.

The solution of the apparatus for showing search results, is capable of obtaining keywords indicating the respective search intents and search results corresponding to the respective keywords, after receiving a search word input by a user that corresponds to a plurality of search intents; generating a first search result page based on the respective keywords and a second search result page based on the search results corresponding to the respective keywords; subsequently, showing the second search result page, and showing the first search result page at a predefined position of the second search result page, in response to a first triggering operation on the second search result page. It is achieved that the displaying of the first search result page containing the keywords corresponding to the respective search contents of the search word is triggered through an interaction operation on the second search result page, which not only can avoid the reading interference led by directly displaying the respective keywords to a user, but also can filter all the search results of the search word with the keywords, and thus improves the efficiency of filtering the search results.

In some embodiments, the search result page showing module 1040 is specifically configured to:
create a hover window on the second search result page, and show the first search result page in the hover window;
or, show the first search result page overlaying the second search result page;
or, swipe from the second search result page to the first search result page along the operation direction of the first triggering operation;
or, move the search results corresponding to the respective keywords on the second search result page along the operation direction of the first triggering operation, and display the first search result page on the vacated area of the second search result page.

In some embodiments, the apparatus for showing search results 1000 further comprises a category search result showing module, configured to:
after showing the first search result page at the predefined position of the second search result page in response to the first triggering operation on the second search result page, if a second triggering operation on the target keyword among the respective keywords is detected, the search results corresponding to the target keyword are displayed on the terminal display interface.

In some embodiments, the category search result showing module is specifically configured to:
display the first search result page in a first area of the terminal display interface; wherein, the first area is an area within a setting range of the terminal display interface in the operation direction of the first trigger operation; and
display the search results corresponding to the target keyword in a second region of the terminal display interface; wherein, the second area is the remaining area in the terminal interface other than the first area.

Further, the apparatus for showing search results 1000 further comprises a search result continuing to display module, configured to:
after displaying the search results corresponding to the target keyword in the second region of the terminal display interface, continue to display the search results corresponding to the target keyword along an operation direction of a third triggering operation if the third triggering operation on the second area is detected; wherein, the operation direction of the third trigger operation is the same as that of the first trigger operation.

Further, the apparatus for showing search results 1000 further comprises a predefined control display module, configured to:
after continuing to display the search results corresponding to the target keyword along the operation direction of the third triggering operation, display a predefined control at the top of the terminal display interface along a second direction after displaying the predefined quantity of the search results corresponding to the target keyword.

Herein, the second direction is opposite to the operation direction of the first triggering operation, and the predefined control is configured to trigger the continuing to display of the predefined quantity of un-displayed search results from the search results corresponding to the target keyword.

In some embodiments, the search result page showing module 1040 is also specifically configured to:
if a fourth triggering operation to the terminal display interface is detected, the first search result page is re-displayed on the terminal display interface; wherein, the fourth triggering operation is the same as the first triggering operation.

In some embodiments, the respective keywords are shown on the first search result page in a distinguishable display style.

Herein, the display style of any one of the keywords is determined based on a relevance of the corresponding keyword to the search word and/or a click-through rate of the keyword, and the display style comprises at least one of a font size, a color, a display position, and a showing area of the search results.

In some embodiments, the search intent is a polysemous search intent or a multi-topic search intent.

It is noted that the apparatus for showing search results 1000 shown in FIG. 10 may perform various steps in the embodiments of the method shown in FIGS. 1-9, and implement various processes and effects in the embodiments of the method shown in FIGS. 1-9, which are not described herein repeatedly.

Embodiments of the present disclosure also provide a device for showing search results. The device for showing search results may comprise a processor and a memory which may be configured to store executable instructions. The processor may be configured to read the executable instructions from the memory, and execute the executable instructions to implement the method for showing search results in the embodiments described above.

FIG. 11 illustrates a schematic diagram of the structure of a device for showing search results provided by embodiments of the present disclosure. The following specifically refers to FIG. 11, which illustrates a schematic diagram of a structure applicable to implement the device for showing search results 1100 in the embodiments of the present disclosure.

The device for showing search results 1100 in the embodiments of the present disclosure may be an electronic device. Herein, the electronic device may include but is not limited to a mobile terminal such as a mobile phone, a laptop computer, a digital broadcast receiver, a PDA (personal digital assistant), a PAD (tablet computer), a PMP (portable multimedia player), an in-vehicle terminal (e.g., a vehicle navigation terminal), a wearable device, and the like, as well as a fixed terminal such as a digital TV, a desktop computer, a smart home device, and the like.

It is noted that the device for showing search results 1100 illustrated in FIG. 11 is only an example and should not impose any limitations on the functionality and scope of the use of embodiments of the present disclosure.

As shown in FIG. 11, the device for showing search results 1100 may comprise a processing apparatus (e.g., a central processor, a graphics processor, etc.) 1101 that may perform various appropriate actions and processes according to the programs stored in read-only memory (ROM) 1102 or the programs loaded from the storage apparatus 1108 into random access memory (RAM) 1103. The various programs and data necessary for the operation of the device for showing search results 1100 are also stored in the RAM 1103. The processing apparatus 1101, the ROM 1102, and the RAM 1103 are connected to each other via a bus 1104. An input/output interface (I/O interface) 1105 is also connected to the bus 1104.

Typically, the following apparatus may be connected to the I/O interface 1105: an input apparatus 1106 comprising, for example, a touch screen, a touchpad, a keyboard, a mouse, a camera, a microphone, an accelerometer, a gyroscope, and the like; an output apparatus 1107 comprising, for example, a liquid crystal display (LCD), a speaker, a vibrator, and the like; a storage apparatus 1108 including, for example, a magnetic tape, a hard disk, and the like; and a communication apparatus 1109. The communication apparatus 1109 may allow the device for showing search results 1100 to communicate with other devices wirelessly or wired to exchange data. Although FIG. 11 illustrates the device for showing search results 1100 with various apparatuses, it should be understood that it is not required to implement or comprise all of the illustrated apparatuses. More or fewer apparatuses may alternatively be implemented or comprised.

Embodiments of the present disclosure also provide a computer-readable storage medium that comprises computer programs stored thereon, when the computer programs are executed by a processor, causing the processor to implement the method for showing search results in the embodiments described above.

In particular, according to the embodiments of the present disclosure, the process described above with reference to the flowchart can be implemented as a computer software program. For example, embodiments of the present disclosure comprise a computer program product comprising computer programs carried on a non-transitory computer-readable medium, the computer program containing program codes for executing the method shown in the flowchart. In these embodiments, the computer program may be downloaded and installed from a network via the communication apparatus 1109, or installed from the storage apparatus 1108, or installed from the ROM 1102. When this computer program is executed by the processing apparatus 1101, the described functionalities defined in the method for displaying information of the embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned device for showing search results, or may also exist alone without being assembled into the device for showing search results.

The above-mentioned computer-readable medium carries one or more programs, when executed by the device for showing search results, causing the device for showing search results to perform the steps of each embodiment of the above method for showing the search results.

In the embodiments of the present disclosure, the computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of device, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for showing search results, comprises:
receiving a search word, the search word corresponds to a plurality of search intents;
obtaining keywords indicating the respective search intents and search results corresponding to the respective keywords;
generating a first search result page and a second search result page; wherein, the first search result page is configured to show the respective keywords, and the second search result page is configured to show the search results corresponding to the respective keywords; and
wherein, the keywords are configured to filter the search results corresponding to the respective keywords; and
showing the second search result page, and showing the first search result page at a predefined position of the second search result page, in response to a first triggering operation on the second search result page.

2. The method of the claim 1, wherein the showing the first search result page at the predefined position of the second search result page comprises:
creating a hover window on the second search result page, and showing the first search result page in the hover window; or
showing the first search result page overlaying the second search result page; or
swiping from the second search result page to the first search result page, along the operation direction of the first triggering operation; or
moving the search results corresponding to the respective keywords on the second search result page along the operation direction of the first triggering operation, and displaying the first search result page on the vacated area of the second search result page.

3. The method of the claim 1, after showing the first search result page at the predefined position of the second search result page, in response to the first triggering operation on the second search result page, further comprising:
displaying search results corresponding to a target keyword among the respective keywords on a terminal display interface, if a second triggering operation on the target keyword is detected.

4. The method of the claim 3, wherein the displaying the search results corresponding to the target keyword on the terminal display interface comprises:
displaying the first search result page in a first area of the terminal display interface;
wherein, the first area is an area within a setting range of the terminal display interface in an operation direction of the first trigger operation; and
displaying the search results corresponding to the target keyword in a second region of the terminal display interface; wherein the second area is a remaining area in the terminal display interface other than the first area.

5. The method of the claim 4, after the displaying the search results corresponding to the target keyword in the second region of the terminal display interface, further comprising:
continuing to display the search results corresponding to the target keyword along a operation direction of a third triggering operation, if the third triggering operation on the second area is detected; wherein, the operation direction of the third trigger operation is the same as that of the first trigger operation.

6. The method of the claim 5, after the continuing to display the search results corresponding to the target keyword along the operation direction of the third triggering operation, further comprising:
displaying a predefined control at a top of the terminal display interface along a second direction after displaying a predefined quantity of the search results corresponding to the target keyword;
wherein, the second direction is opposite to the operation direction of the first triggering operation, and wherein the predefined control is configured to trigger continuing to display of the predefined quantity of un-displayed search results from the search results corresponding to the target keyword.

7. The method of the claim 3, further comprising:
re-displaying the first search result page on the terminal display interface, if a fourth triggering operation to the terminal display interface is detected; wherein, the fourth triggering operation is the same as the first triggering operation.

8. The method of the claim 1, wherein the respective keywords are shown on the first search result page in a distinguishable display style;
wherein, the display style of any one of the keywords is determined based on a relevance of the corresponding keyword to the search word and/or a click-through rate of the keyword, and
wherein the display style comprises at least one of a font size, a color, a display position, and a showing area of the search results.

9. The method of the claim 1, wherein the search intents are a polysemous search intent or a multi-topic search intent.

10. (canceled)

11. A device for showing search results, comprises:
a processor;
a memory, configured to store executable instructions;
wherein, the processor is configured to read the executable instructions from the memory, and execute the executable instructions to:
receive a search word, the search word corresponds to a plurality of search intents;
obtain keywords indicating the respective search intents and search results corresponding to the respective keywords;
generate a first search result page and a second search result page; wherein, the first search result page is configured to show the respective keywords, and the second search result page is configured to show the search results corresponding to the respective keywords; and wherein, the keywords are configured to filter the search results corresponding to the respective keywords; and
show the second search result page, and showing the first search result page at a predefined position of the second search result page, in response to a first triggering operation on the second search result page.

12. A computer-readable storage medium, wherein the storage medium comprises computer programs stored thereon, when executed by a processor, cause the processor to:
receive a search word, the search word corresponds to a plurality of search intents;
obtain keywords indicating the respective search intents and search results corresponding to the respective keywords;
generate a first search result page and a second search result page; wherein, the first search result page is configured to show the respective keywords, and the second search result page is configured to show the search results corresponding to the respective keywords; and wherein, the keywords are configured to filter the search results corresponding to the respective keywords; and
show the second search result page, and showing the first search result page at a predefined position of the second search result page, in response to a first triggering operation on the second search result page.

13. (canceled)

14. The device of the claim 11, wherein the showing the first search result page at the predefined position of the second search result page comprises:
create a hover window on the second search result page, and showing the first search result page in the hover window; or
show the first search result page overlaying the second search result page; or
swipe from the second search result page to the first search result page, along the operation direction of the first triggering operation; or
move the search results corresponding to the respective keywords on the second search result page along the operation direction of the first triggering operation, and displaying the first search result page on the vacated area of the second search result page.

15. The device of the claim 11, wherein after showing the first search result page at the predefined position of the second search result page, in response to the first triggering operation on the second search result page, the processor executes the executable instructions further to:
display search results corresponding to a target keyword among the respective keywords on a terminal display interface, if a second triggering operation on the target keyword is detected.

16. The device of the claim 15, wherein the displaying the search results corresponding to the target keyword on the terminal display interface comprises:
displaying the first search result page in a first area of the terminal display interface;
wherein, the first area is an area within a setting range of the terminal display interface in an operation direction of the first trigger operation; and
displaying the search results corresponding to the target keyword in a second region of the terminal display interface; wherein the second area is a remaining area in the terminal display interface other than the first area.

17. The device of the claim 16, wherein after the displaying the search results corresponding to the target keyword in the second region of the terminal display interface, the processor executes the executable instructions further to:
continue to display the search results corresponding to the target keyword along a operation direction of a third triggering operation, if the third triggering operation on the second area is detected; wherein, the operation direction of the third trigger operation is the same as that of the first trigger operation.

18. The device of the claim 17, wherein after the continuing to display the search results corresponding to the target keyword along the operation direction of the third triggering operation, the processor executes the executable instructions further to:
display a predefined control at a top of the terminal display interface along a second direction after displaying a predefined quantity of the search results corresponding to the target keyword;
wherein, the second direction is opposite to the operation direction of the first triggering operation, and wherein the predefined control is configured to trigger continuing to display of the predefined quantity of un-displayed search results from the search results corresponding to the target keyword.

19. The device of the claim 15, wherein the processor executes the executable instructions further to:
re-display the first search result page on the terminal display interface, if a fourth triggering operation to the terminal display interface is detected; wherein, the fourth triggering operation is the same as the first triggering operation.

20. The device of the claim 11, wherein the respective keywords are shown on the first search result page in a distinguishable display style;
wherein, the display style of any one of the keywords is determined based on a relevance of the corresponding keyword to the search word and/or a click-through rate of the keyword, and
wherein the display style comprises at least one of a font size, a color, a display position, and a showing area of the search results.

21. The device of the claim 11, wherein the search intents are a polysemous search intent or a multi-topic search intent.

22. The computer-readable storage medium of the claim 12, wherein the showing the first search result page at the predefined position of the second search result page comprises:
creating a hover window on the second search result page, and showing the first search result page in the hover window; or
showing the first search result page overlaying the second search result page; or
swiping from the second search result page to the first search result page, along the operation direction of the first triggering operation; or
moving the search results corresponding to the respective keywords on the second search result page along the operation direction of the first triggering operation, and displaying the first search result page on the vacated area of the second search result page.
